(19) United States
(12) Patent Application Publication
(10) Pub. No.: US 2013/0060885 A1
(43) Pub. Date: Mar. 7, 2013

(54) METHOD AND APPARATUS FOR ENABLING OFFLINE WEB APPLICATION EXECUTION

(71) Applicant: Yan Fu, Espoo (FI)

(72) Inventor: Yan Fu, Espoo (FI)

(73) Assignee: Nokia Corporation, Espoo (FI)

(21) Appl. No.: 13/224,905

(22) Filed: Sep. 2, 2011

(51) Int. Cl. G06F 15/16

(52) U.S. Cl. 709/217

(57) ABSTRACT

An approach is provided for providing client-side caching of content using one or more web cookies. A data caching module determines a request from a device for specifying content data directed to at least one web server, at least one storage destination, or a combination thereof. The data caching module processes the content data for storage in one or more web cookies, then causes transmission of the content data via the one or more web cookies to the at least one web server, the at least one storage destination, or a combination thereof based on the request.

### BACKGROUND

Network service providers and device manufacturers are continually challenged to deliver value and convenience to consumers by, for example, providing compelling network services. One network feature that greatly improves the user experience is client-side persistence or caching of content entered during offline use of an Internet browser, web service or other network based tool. Client-side persistence or caching enables client devices to locally store information for authenticating, session tracking (e.g., state maintenance), etc., and for remembering specific information about users such as service preferences, browsing history, previous activities and the like. In addition, many network based tools are configured to support caching of user provided content entered during the data entry process. This information can be used to provide continuity in a user's service experience when the user begins a service session (e.g., a web browsing session) and then resumes the session at a later time. However, this capability is limited in instances where the web browser or other network based tool at the device is not configured to support client-side caching or when the network is unavailable.

### SOME EXAMPLE EMBODIMENTS

Therefore, there is a need for an alternative approach for providing client-side caching of content.

According to one embodiment, a method comprises determining a request from a device, the request specifying content data directed to at least one web server, at least one storage destination, or a combination thereof. The method also comprises processing and/or facilitating a processing of the content data for storage in one or more web cookies. The method further comprises causing, at least in part, a transmission of the content data via the one or more web cookies to the at least one web server, the at least one storage destination, or a combination thereof based, at least in part, on the request.

According to another embodiment, an apparatus comprises at least one processor, and at least one memory including computer program code for one or more computer programs, the at least one memory and the computer program code configured to, with the at least one processor, cause, at least in part, the apparatus to determine a request from a device, the request specifying content data directed to at least one web server, at least one storage destination, or a combination thereof. The apparatus is also caused to process and/or facilitate a processing of the content data for storage in one or more web cookies. The apparatus is further caused to cause, at least in part, a transmission of the content data via the one or more web cookies to the at least one web server, the at least one storage destination, or a combination thereof based, at least in part, on the request.

According to another embodiment, a computer-readable storage medium carries one or more sequences of one or more instructions which, when executed by one or more processors, cause, at least in part, an apparatus to determine a request from a device, the request specifying content data directed to at least one web server, at least one storage destination, or a combination thereof. The apparatus is also caused to process and/or facilitate a processing of the content data for storage in one or more web cookies. The apparatus is further caused to cause, at least in part, a transmission of the content data via the one or more web cookies to the at least one web server, the at least one storage destination, or a combination thereof based, at least in part, on the request.

According to another embodiment, an apparatus comprises means for determining a request from a device, the request specifying content data directed to at least one web server, at least one storage destination, or a combination thereof. The apparatus also comprises means for processing and/or facilitating a processing of the content data for storage in one or more web cookies. The apparatus further comprises means for causing, at least in part, a transmission of the content data via the one or more web cookies to the at least one web server, the at least one storage destination, or a combination thereof based, at least in part, on the request.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing client-side caching of content using one or more web cookies, according to one embodiment;

FIG. 2 is a diagram of the components of a data caching module, according to one embodiment;

FIGS. 3A-3D are flowcharts of a process for providing client-side caching of content using one or more web cookies, according to various embodiments;

FIGS. 4A-4C are diagrams of user interfaces depicting interaction between a browser and a web server for supporting client-side caching, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for providing client-side caching of content using one or more web cookies are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

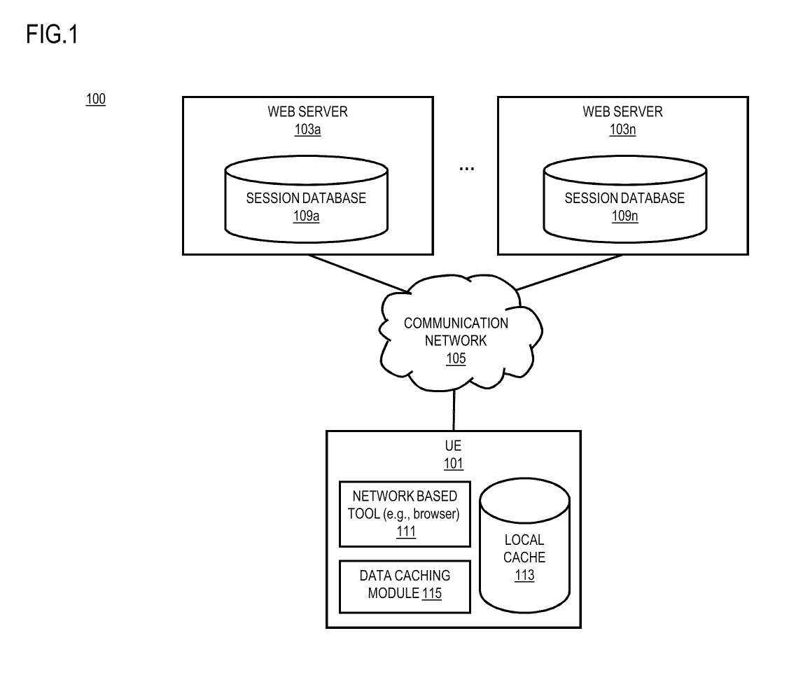

FIG. 1 is a diagram of a system capable of providing client-side caching of content using one or more web cookies, according to one embodiment. In certain embodiments, the system 100 is configured to support offline and/or online execution of network based tools, such as web browsers, Internet portal applications, web service applications, or the like. Offline execution may include, for example, functional operation of the various features of a network based tool in instances of limited or no access to a web server 103a-103n, communication network 105, or the like. This may include, for example, any operations requiring the entry or exchange of data and other content (e.g., image data, audio data) by a user at network capable user device, i.e., user equipment (UE) 101.

Many applications store data for completing or continuing application (e.g., web application) functions and tasks on the user device (i.e., client-side) rather than exclusively at the server, i.e., offline execution. In this way, applications can reduce server load and complete internet tasks on the client-side as needed. The data stored or cached at the user device is generally referred to as client-side persistent data. Some web browsers, internet portals and the like are configured to readily support both online and offline execution by a user. For example, web browsers that are HTML5 capable feature built-in semantics for enabling content to be captured offline and subsequently provided to a target web server during online use. The HTML5 protocol calls for the browser to read a list of URLs referencing the various resources the browser requires to access a target web service offline, download the resources, cache them locally, and automatically keep the locally stored copies up-to-date as they change. By way of this approach, the most up-to-date version of the data is provided once online execution is established.

Unfortunately, devices that are not configured to execute HTML5 or other protocols are unable to support both online and offline execution. By way of example, in many developing countries, users often employ mobile devices without full-fledged HTML5 browsers. Furthermore, these countries may not have the reliable network connections required by users to sustain online execution. Hence, the users are limited in their ability to enable both online and offline execution given limited network access and sub-optimal browser availability. Moreover, such users are unable to create new content while offline and have the content uploaded when users are online later.

To address this problem, a system 100 of FIG. 1 introduces the capability of employing the use of one or more web cookies as a means and mechanism of client-side data caching. More specifically, the system 100 enables content directed to at least one web server 103a by a user at a device, i.e., user equipment (UE) 101, to be segregated and stored to one or more web-cookies. As shown in FIG. 1, the system 100 comprises a user equipment (UE) 101 having connectivity to one or more web servers 103a-103n via a communication network 105. In one embodiment, the UE 101 can access information or web content from a website managed by the one or more of the servers 103a-103n. In addition, content generated by way of input at the device—i.e., via the keyboard, keypad, touch input, voice input, or other input means—can be transmitted to servers 103a-103n to facilitate session interaction.

For example, the UE 101 sends a request for the web content to at least one of the servers 103a-103n using a browser application (e.g., network based tool 111). On receipt of the request, the web server 103 generates web content code (e.g., hypertext markup language (HTML) code) in response, such as for presentment or execution by the browser 111. The client/server interaction between the UE 101 and respective servers 103a-103n, including when offline status is determined, is carried out by transmitting web cookies as stored to local cache 113. Per the exemplary embodiments herein, the system 100 facilitates the transmission process in response to a determination of an online status for the network and/or session.

A web cookie (e.g., a browser cookie or Hypertext Transport Protocol (HTTP) cookie) may include, for example, any small portion of text or other data for being stored to a local device running an application (e.g., web browser). Web cookies consist of one or more name-value pairs containing limited bits of information such as user preferences, shopping cart contents, an identifier for a server-based session, or other data used by websites. This includes, for example, the storing of content regardless of the size of the content.

By way of example, this content storage process is carried out by a data caching module 115 operable in connection with a network based tool (e.g., web browser) 111 of user equipment UE 101. The data caching module 115 is configured to: (1) determine a network connection and/or session status between the network based tool 111 and one or more web servers 103a-103n; (2) determine a number of web cookies required to enable the storing of content as input to the network based tool 111 during offline execution of said tool; and (3) cause generation of one or more web cookies required to store the content based on the determined number of web cookies required, the network connection, the session status, or a combination thereof. With respect to the latter, the data caching module 115 causes the network based tool 111 to generate hypertext transfer protocol (HTTP) web cookies for distributing (e.g., parsing) the content using of an active scripting language. By way of example, when it is determined that the network connection or a once active session between the browser 111 and server(s) 103a-103n is inactive (e.g., offline execution), the data caching module 115 executes a JavaScript for temporarily storing any generated content. The compiler may be configured in accordance with the respective protocols and features of the browser such that this execution is triggered at the time of content generation. Once generated, the one or more web cookies are then stored to a local database, i.e., local cache 113, resident at UE 101.

Distribution of the content across the one or more web cookies by the data caching module is performed based on various factors. This may include, for example, the relative size of the content to be stored, a determined number of web cookies required for storage of the content based on its size, or a combination thereof. Many network based tools 111 place limits on the number and size of web cookies allowed to be generated per UE 101 or per web server 103a-103n. To overcome this limitation, however, the data caching module enables the one or more web cookies to be distributed across respective one or more store paths. The one or more store paths reference the location of the web cookies in local cache 113. In certain embodiments, the path may be in the form of a uniform resource locator (URL), i.e., a direct access memory location, a pointer, etc. For example, one web cookie may reference a store path identifier of http://www.example.com/store/1, while a second web cookie references a store path identifier http://www.example.com/store/2. By assigning multiple distinct paths for the multiple distinct web cookies for distinct portions of the content, the capacity of content storage is increased rather than limited.

The number of store paths to be generated at the device may be based on a 1:1 proportional model as indicated in the aforementioned example. Hence, the number of defined store paths is equivalent to at least the number of web cookies required to store the content. For example, a calculation for determining the relative number of store paths required to distribute content totaling one megabyte is shown below:

OVERALL SIZE OF CONTENT÷MAXIMUM SIZE OF A WEB COOKIE

For a typical web cookie size of 4096 bytes, content of 1 MB (1048576 bytes) must be encapsulated/distributed across at least 256 cookies (1048576 bytes÷4096 bytes per web cookie). Consequently, the data caching module 115 must create at least 256 store paths for accessing/storing respective web cookies to local cache 113. Alternatively, the number of store paths may be generated at the device based on other variables, including the capacity of the local cache 113, device processing speeds, operating system capability, network latency and access status, etc. It is noted, therefore, that the data caching module 115 may be configured to account for any designated restrictions and access policies, including for example, policies for regulating/limiting the number of web cookies allowed to be stored overall or per web server 103a-103n. Also, as will be discussed later, at least one additional store path beyond the determined number is necessary is required for accessing data pertaining to each of the various web cookies and associated store paths as generated.

In certain embodiments, the data caching module 115 also causes transmission of the one or more web cookies to web servers 103a-103n upon detection of an active connection and/or session with the servers 103a-103n. As a result, the content as stored to each web cookie is also conveyed pursuant to the establishment or reestablishment of a network connection, session, or a combination thereof. The content is reconstructed by the web servers 103a-103n as they extract and/or load the content conveyed by the various web cookies. To ensure proper reconstruction of the content, the data caching module 115 designates at least one of the one or more web cookies as a master record. The master record may include, for example, information for conveying which of the one or more web cookies contain one or more portions of the distributed content data. In addition, the master record may indicate the one or more store paths associated with the one or more web cookies, a sequence of accessing of the one or more web cookies from local cache relative to respective store path, or a combination thereof.

To avoid unnecessary data upload to a web server 103a-103n, the store paths shall be reserved only for storing content generated during offline execution. As such, the data caching module ensures the browser 111 does not make a HTTP request to a URL on or under the designated store paths. The data caching module 115 also executes various security measures with respect to the store paths, including for example, performing a concatenating, randomization, lengthening, obfuscating, modifying or a combination thereof of the one or more store paths. Likewise, the content data stored in the one or more web cookies may also be concatenated or the like. This prevents the ability of third party intruders, i.e., malicious websites, from determining the store paths or the associated content.

It is noted that in certain instances, web servers 103a-103n do not need to maintain any reference to the store paths within its session database 109a-109n in instances where it is equipped with a URL rewrite engine (not shown) to achieve the same affect. As such, the rewrite engine may modify the store path identifiers as indicated in the master record at the time of receipt and extraction of the relative content of the one or more web cookies.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). The UE 101 communicates with the web servers 103a-103n and any other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

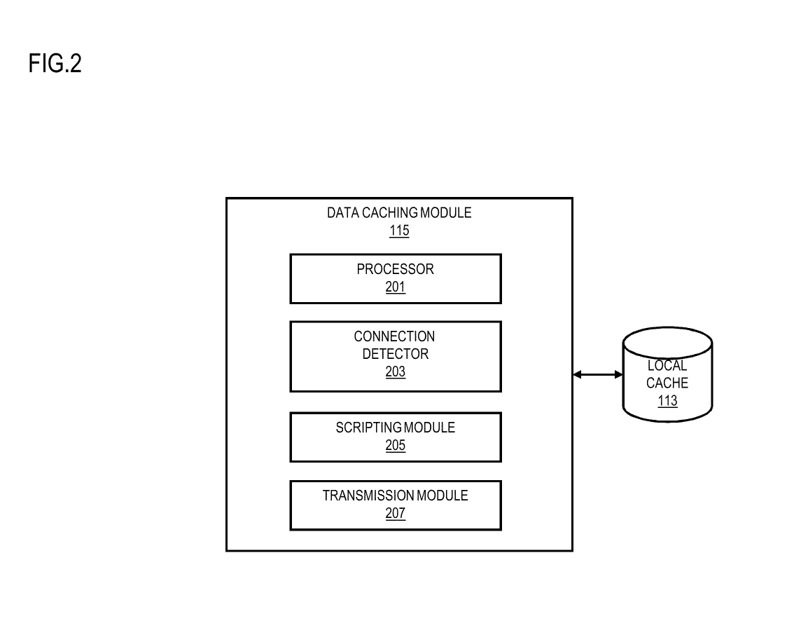

FIG. 2 is a diagram of the components of a data caching module, according to one embodiment. By way of example, the data caching module 115 includes one or more components for providing client-side caching of content using one or more web cookies. It is contemplated that the functions of these components may be combined in one or more components or performed by other components of equivalent functionality. Also, while presented with respect to FIG. 1 in connection with the UE 101, the data caching module 115 may also be implemented as an active component of the server 103a-103n to facilitate client/server interaction with the UE 101. The following description of the components of the data caching module 115 is applicable to any implementation.

In this embodiment, the data caching module 115 includes at least a processor 201 or other control logic for executing at least one algorithm for facilitating operation of the various other modules 203-207. For example, the processor 201 interacts with the connection detector 203 to identify an offline or online status of a network and/or session. In one embodiment, the connection detector 203 may have access to the socket (e.g., the transmission control protocol (TCP) socket) used by the session client 111 to communicate with the web server 103. The connection detector 203 may obtain an identifier (e.g., socket identifier (ID)) associated with the socket to identify the corresponding connection is active (e.g., a persistent connection). Alternatively, the connection detector 203 may employ the use of other status determination messages, including the use of different worker processes/threads to identify the persistent or reusable connection. A processing result may include, for example, an active connection, inactive connection, active session, inactive session, or a combination thereof.

After identifying the connection, the processor 201 interacts with a scripting module 205 for generating one or more web cookies as described with respect to FIG. 1. As noted previously, the one or more web cookies store at least a portion of content intended for direction to the web server. In certain embodiments, the scripting module 205 regulates the distribution of the content across the various web cookies. The scripting module 205 also enables the execution of one or more scripts at the device to cause the storage of the content data in the one or more web cookies. This includes, for example, determining to receive content for direction to the servers, assessing the size of the content, determining a number of web paths to be created in association with each of a respective one or more web cookies for housing the content, and the like. The scripting module 205 also receives the one or more web cookies from the at least one web server.

A transmission module 207 operates in conjunction with the connection detector to automatically trigger transmission of the one or more web cookies in response to a determined online status of the connection and/or session. It is contemplated that the transmission module 207 may support sequential transmission of the one or more web cookies when required by the web server, block/piggybacked data transmission, etc. The master record may be presented for initial conveyance to the web server for enabling proper accessing/retrieval of the one or more web cookies and/or reconstruction of the content at the server.

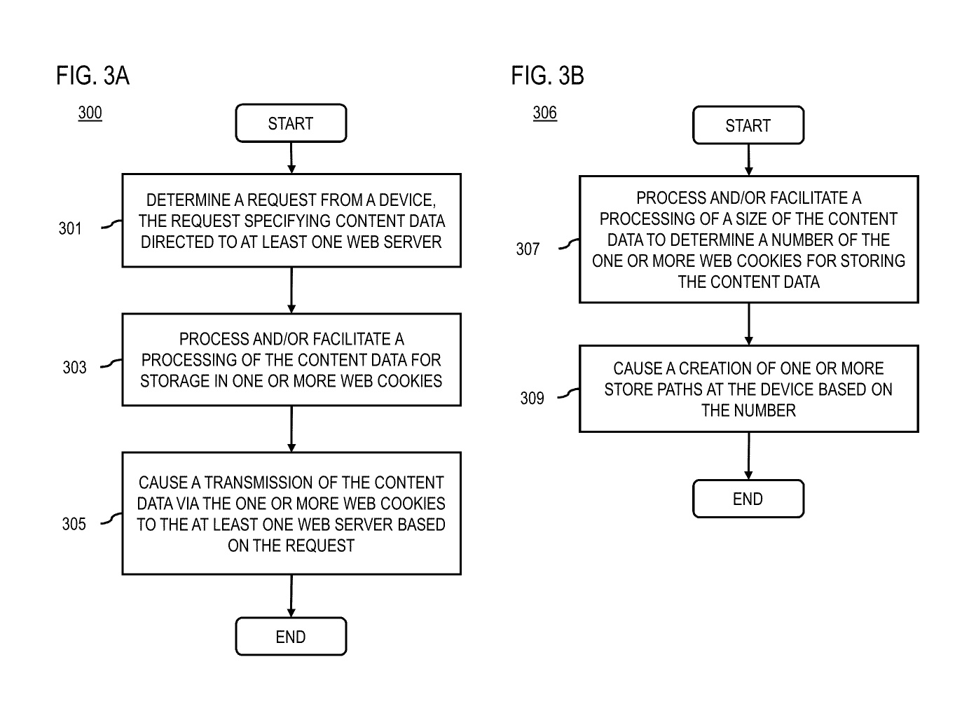

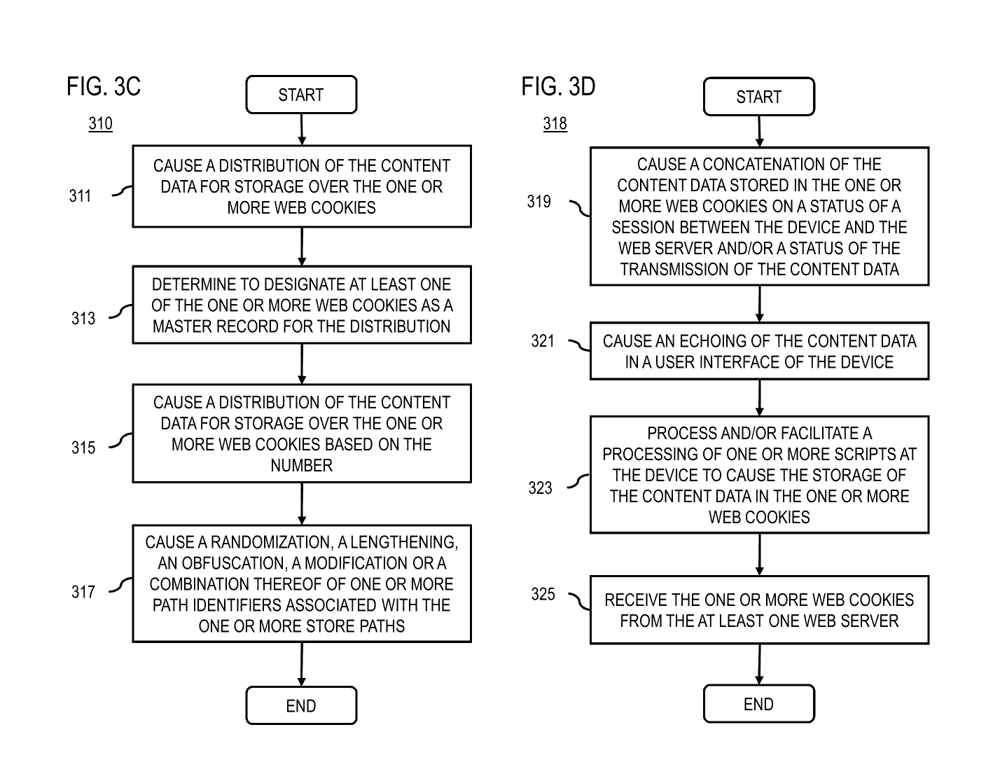

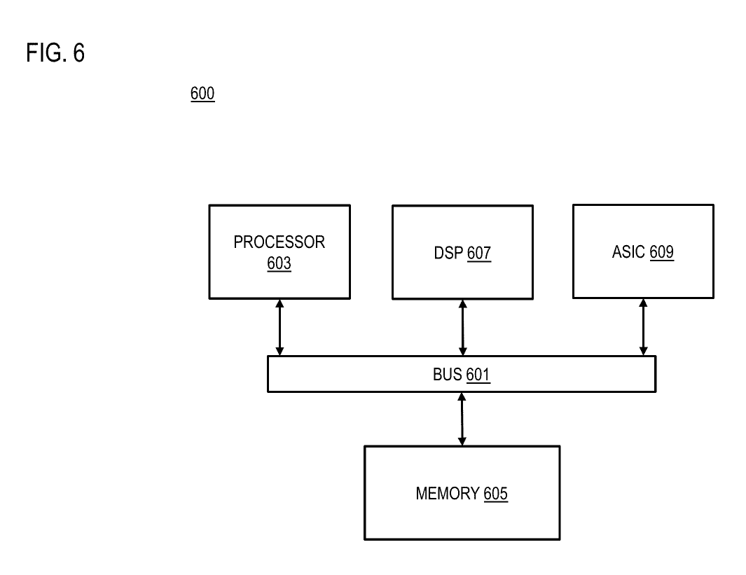

FIGS. 3A-3D are flowcharts of a process for providing client-side caching of content using one or more web cookies, according to various embodiments. In one embodiment, the data caching module 115 performs the process 300 and is implemented in, for instance, a chip set including a processor and a memory as shown in FIG. 6. In step 301, the data caching module 115 determines a request from a device, the request specifying content data directed to at least one web server, at least one storage destination, or a combination thereof. As noted previously, the content data may be received by way of various input mechanisms of the device, including by way of a keyboard, keypad, terminal, microphone, camera, video recorder, touch, voice, or the like. In addition, it is contemplated that the content may be intended for transmission to a web server or for storage (e.g., at least on storage destination) at a device. For example, in one example, the a user may create content (e.g., an email) in a first session, but is interrupted before the user can complete creating the content (e.g., the email). The user can then store the content or other related content (e.g., a note reminding the user of how to continue with the email) using the various embodiments described herein for later access or processing. In this case, the content is for local use at the device (e.g., at a storage destination such as a cache or other store paths as discussed herein) and is not transmitted to a server. In step 303, the data caching module 115 processes and/or facilitates a processing of the content data for storage in one or more web cookies. It is contemplated, in certain embodiments, that the data caching module 115 may support the storing of non-textual content, i.e., video data. Under this scenario, the video data may be encoded and furthermore distributed amongst respective one or more web cookies in binary form for subsequent reconstruction (decoding) at the web server.

Per step 305, the data caching module 115 causes a transmission of the content via the one or more web cookies to the at least one web server, the at least one storage destination, or a combination thereof based on the request. This process is facilitated based at least in part on a change in status from offline with respect to the at least one web server, to online. Hence, as noted previously, transmission of the one or more web cookies is performed responsive to the establishment or reestablishment of a network connection and/or web session to support a continuous, persistent session experience.

In step 307 of process 306, the data caching module 115 processes and/or facilitates a process of a size of the content data to determine a number of the one or more web cookies for storing the content data. Per step 309, the data caching module 115 causes a creation of one or more store paths at the device based on the number. As noted previously, the one or more store paths are for storage of the one or more web cookies at the device. The one or more paths permit accessing of the content as stored to respective one or more web cookies by the web server in response to the establishment or reestablishment of a network connection and/or web session.

In process 310, the steps for managing distribution of the various store paths relative to one or more web cookies are presented. In a step 311, the data caching module causes a distribution of the content data for storage over the one or more web cookies. In another step 313, the data caching module 115 determines to designate at least one of the one or more web cookies as a master record for the distribution. The master record indicates, at least in part, which of the one or more web cookies contain one or more portions of the distributed content data, the one or more store paths associated with the one or more web cookies, a sequence of accessing of the one or more web cookies, or a combination thereof for distributing the data caching module 115. Hence, per step 315, the data caching module 115 causes a distribution of the content data for storage over the one or more web cookies based on the determined number of store paths to be created. It is noted that the sequence of accessing of the one or more web cookies may also correspond to a pace, order or sequence of transmission of the one or more web cookies in response to detection of an online status with the web server.

Per step 317, the data caching module 115 may operate in connection with the web server to support various data masking and/or restriction features. The data caching module causes a randomization, a lengthening, an obfuscation, a modification or a combination thereof of one or more path identifiers associated with the one or more store paths.

As a further means of facilitating a web session on the basis of the one or more web cookies, the data caching module 115 causes a concatenation of the content data stored in the one or more web cookies based, at least in part, on a status of a session between the device and the web server, a status of the transmission of the content data, or a combination thereof. This corresponds to step 319 of process 318. Per step 321, the data caching module 115 causes an echoing of the content data in a user interface of the device. The echo process provides a means of verification of receipt of the one or more web cookies by the web server.

In another step 323, one or more scripts are causes to be processes at the device to cause the storage of the content data in the one or more web cookies. The scripts may correspond to any scripting language for supporting the encoding, storing or referencing of content data. Per step 325, the module 115 receives the one or more web cookies from the at least one web server.

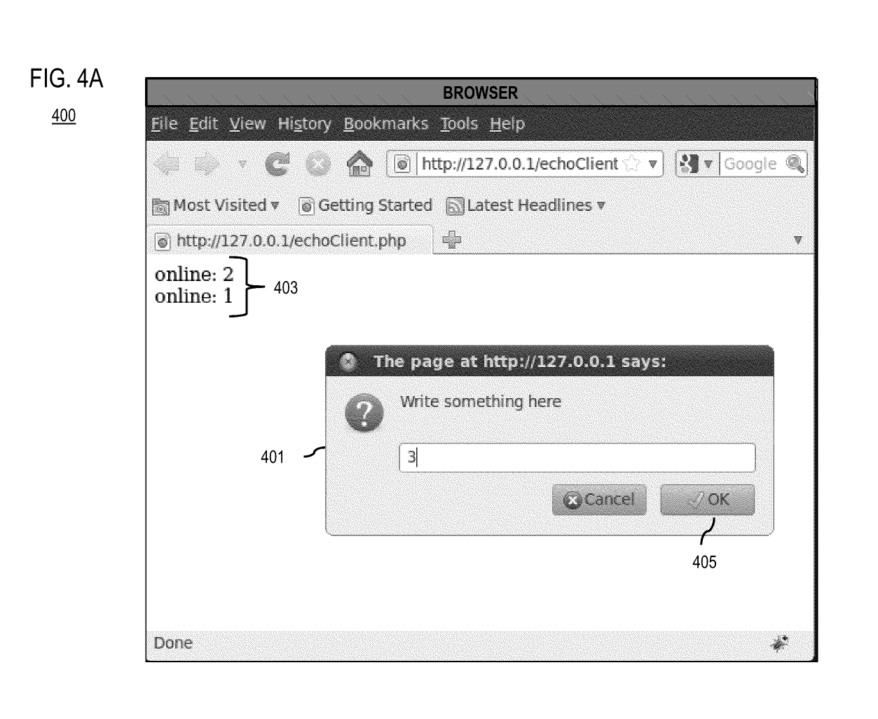

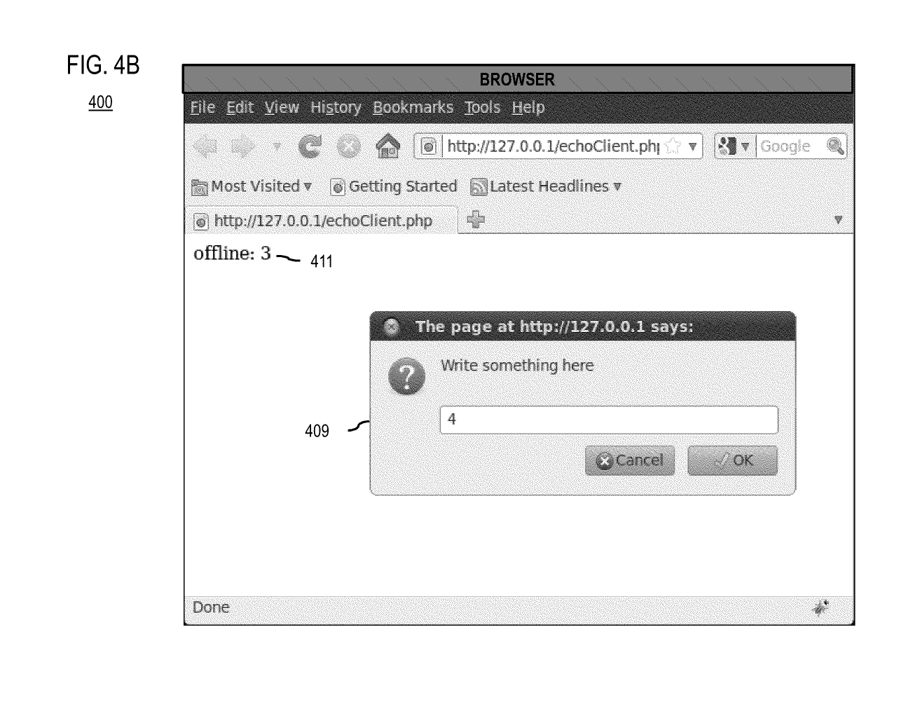

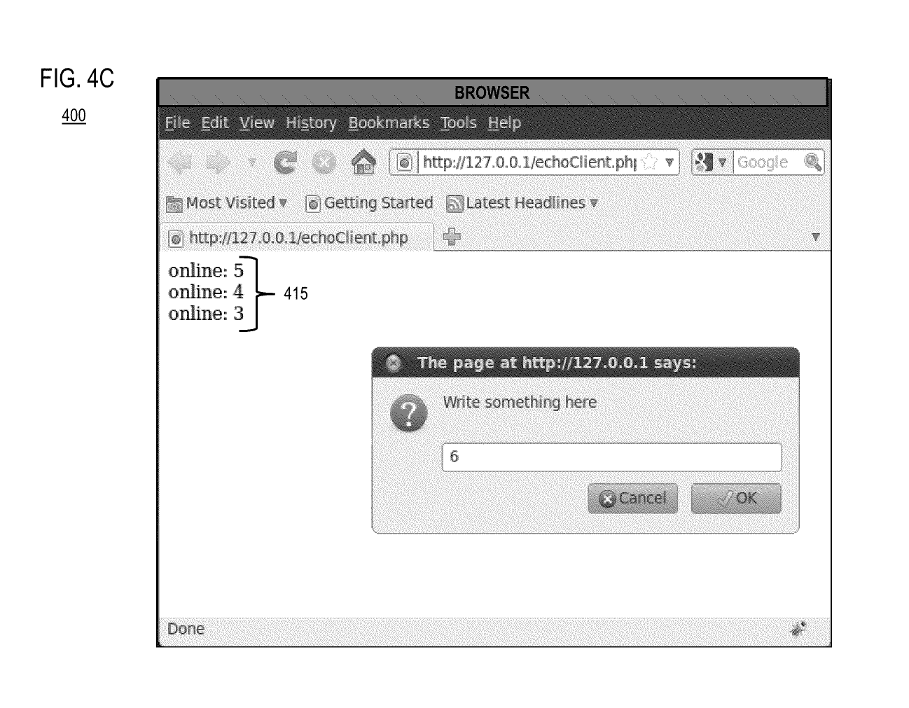

FIGS. 4A-4C are diagrams of user interfaces depicting interaction between a browser and a web server for supporting client-side caching, according to various embodiments. For the purpose of illustration, the figures are described with respect to a use case of a browser engaging the server for initially online, then offline execution. By way of example, the web server being engaged by the browser is an Echo service, which is a service for enabling the web server to send back a copy of the identical data it received from the browser. Exemplary source code for implementation of the Echo service based on a determined offline status is presented later with respect to TABLE 2.

In FIG. 4A, a user loads a webpage referenced by URL http://127.0.0.1/echClient.php, a dedicated server for running the Echo service. This corresponds to an online status with the web server. The user then types in a text string “1” and subsequently “2” at a data entry window 401, then selects the “OK” action button 405 to submit the data. The response includes the web server concatenating “online:” to the entered strings (e.g., 1, 2) and returning them back to the browser as text 403 for presenting “online: 1” and “online: 2” It is noted that upon selecting the “OK” action button 405, the content can be also caused to be stored to one or more web cookies and stored to local cache of the device according to one or more store paths. In some embodiments, if the device is online, then the content can be sent directly to the appropriate server without being stored locally. Hence, this action may be performed during online execution as well.

At a later time, the user closes the browser 400 causing a discontinuing of the session with and the web server executing the Echo service (e.g., offline status). In other instances, the active connection to the communication network 105 may be lost. The user then opens the browser and chooses to activate it for offline execution, corresponding to FIG. 4B. As noted previously, the offline and/or online status may be specified directly by the user or detected accordingly.

Once the browser is invoked, the user types in the URL http://127.0.0.1/echoClient.php in the browser again. Resultantly, the user can still input strings at the data entry window 409, but the strings are not sent to the web server due to offline status. Instead, the one or more cookies store the strings as entered. This enables the browser 400 to echo back the strings as entered to the user interface UI, but they are concatenated with a different word, “offline:”, to show the differences. By way of example, when the user enters the string “3,” the string “offline: 3” 411 is returned. The user also enters text strings “4” and “5”, then closes the browser 400.

With reference to FIG. 4C, the user reopens the browser 400 at a later time and establishes a connection with the server (e.g., online status). Once again, the user accesses the URL http://127.0.0.1/echClient.php for loading the Echo service. Having determined the online status, the web browser is caused to convey the one or more web cookies containing respective content/strings “3,” “4,” and “5.” The web server accesses the strings from the local cache of the device on the basis of the respective one or more store paths for the one or more web cookies, i.e., as specified in the master record. Responsive to receipt of the web cookies, server returns the strings as concatenated “online:”, corresponding to text display 415. The user may further continue to enter other strings.

In one embodiment, JavaScript can be used as the language of the scripting file associated with the web content. TABLE 2 is a sample implementation of the session using JavaScript and HTML encoding. For the purpose of illustration, a brief description is presented at various sections of the code, with various of the executions corresponding to the processes of FIGS. 3A-3D.

TABLE 2
<html>
<head>
<script language=″javascript″>
var isFirstTime = true;
/////////////////////////////////////////// EXECUTION 1 /////////////////////////////////////////////
This is the function to get called when cacheable scripts are loaded and ready to read/save data at
browsers. The actual function is defined by web application.
function foo( ) {
var http = null;
var store = document.getElementById(″store″).contentWindow;
var content = store.getOfflineContent( );
/////////////////////////////////////////// EXECUTION 2 /////////////////////////////////////////////
If this is the first time the browser renders this page, checks whether there is existing offline data,
and if so, send to the web server (e.g., web cookies)
if (isFirstTime && content) {
isFirstTime = false;
http = new XMLHttpRequest( );
http.onreadystatechange = function( ) {
if (http.readyState==4) {
if (http.status==200) {
/////////////////////////////////////////// EXECUTION 3 /////////////////////////////////////////////
If the server is online, delete offline data from the “local storage”, which was just synced to the
server
document.getElementById(″history″).innerHTML = http.responseText;
store.deleteOfflineContent( );
} else {
/////////////////////////////////////////// EXECUTION 4 /////////////////////////////////////////////
If the server is offline, browser displays offline data but append “offline:” to them
document.getElementById(″history″).innerHTML = ″offline: ″ + content.replace(″,″,
″<br>offline: ″);
}
}
}
http.open(″get″, ″echoServer.php?line=″ + content, true);
http.send( );
}
var line = prompt(″Write something here″);
if (line) {
/////////////////////////////////////////// EXECUTION 5 /////////////////////////////////////////////
User gives a new input while offline
var http = new XMLHttpRequest( );
http.onreadystatechange = function( ) {
if (http.readyState==4) {
if (http.status==200) {
/////////////////////////////////////////// EXECUTION 6 /////////////////////////////////////////////
If server is online, it returns a string by appending “online:” to the new input, here browser just
prints it
document.getElementById(″history″).innerHTML = http.responseText + ″<br>″ +
document.getElementById
(″history″).innerHTML;
} else if (http.status === 0) {
/////////////////////////////////////////// EXECUTION 7 /////////////////////////////////////////////
If the server is offline, the new input is appended to the “offline store” at the specified URL path
content = store.getOfflineContent( );
if (content) {
content = line + ″,″ + content;
} else {
content = line;
}
store.setOfflineContent(content);
document.getElementById(″history″).innerHTML = ″offline: ″ + line + ″<br>″ +
document.getElementById
(″history″).innerHTML;
}
foo( );
}
}
/////////////////////////////////////////// EXECUTION 8 /////////////////////////////////////////////
Browser tries to upload the new input to server
http.open(″get″, ″echoServer.php?line=″ + line, true);
http.send( );
}
}
</script>
</head>
<body>
/////////////////////////////////////////// EXECUTION 9 /////////////////////////////////////////////
This invisible iframe is used to load cacheable script into browser memory. Communication with
remote server takes
place only for the first time.
<iframe id=″store″ width=″0″ height=″0″ style=″display: none;″ src=″store/store.html″
onload=″foo( );″></iframe>
<div id=″history″></div>
</body>
</html>
y3fu@y3fu-desktop:/var/www$ cat store/store.html <NOTE: This file is the cacheable script file
or HTML document on different paths>
<html><head>
<script language=″javascript″>
/////////////////////////////////////////// EXECUTION 10 /////////////////////////////////////////////
This function loads a cookie from the path using well known functions getCookie and setCookie
function getCookie(check_name) {
var a_all_cookies = document.cookie.split(′;′);
var a_temp_cookie = ″;
var cookie_name = ″;
var cookie_value = ″;
var b_cookie_found = false; // set boolean t/f default f
for (i=0; i<a_all_cookies.length; i++ ) {
a_temp_cookie = a_all_cookies[i].split(′=′);
cookie_name = a_temp_cookie[0].replace(/\hat{ }\s+|\s+$/g, ″);
if (cookie_name == check_name) {
b_cookie_found = true;
if (a_temp_cookie.length > 1) {
cookie_value = unescape(a_temp_cookie[1].replace(/\hat{ }\s+|\s+$/g, ″));
}
return cookie_value;
}
a_temp_cookie = null;
cookie_name = ″;
}
if (!b_cookie_found) {
return null;
}
}
function setCookie(name, value, expires, path, domain, secure) {
var today = new Date( );
today.setTime( today.getTime( ) );
// in days
if (expires) {
expires = expires * 1000 * 60 * 60 * 24;
var expires_date = new Date(today.getTime( ) + expires);
document.cookie = name + ″=″ +escape(value) +
((expires) ? ″;expires=″ + expires_date.toGMTString( ) : ″″ ) +
((path) ? ″;path=″ + path : ″″ ) +
((domain) ? ″;domain=″ + domain : ″″ ) +
((secure) ? ″;secure″ : ″″ );
}
function deleteCookie( name, path, domain ) {
if (getCookie(name)) {
document.cookie = name + ″=″ +
((path) ? ″;path=″ + path : ″″) +
((domain) ? ″;domain=″ + domain : ″″ ) +
″;expires=Thu, 01-Jan-1970 00:00:01 GMT″;
}
}
/////////////////////////////////////////// EXECUTION 11 /////////////////////////////////////////////
Rely on functions above to read/write offline content
function setOfflineContent(content) {
if (content) {
setCookie(″o″, content, 30);
}
}
function getOfflineContent( ) {
return getCookie(″o″);
}
function deleteOfflineContent( ) {
return deleteCookie(″o″);
}
</script>
</head>
<body></body></html>
y3fu@y3fu-desktop:/var/www$ cat echoServer.php
/////////////////////////////////////////// EXECUTION 12 /////////////////////////////////////////////
A sample web application on the server side. It adds “online:” to a string it receives from URL
parameter and returns
it to the browser.
<?php
header(″Cache-Control: no-cache, no-store″);
echo ″online: ″.str_replace(″,″, ″<br>online: ″, $_GET[″line″]);
?>

The processes described herein for providing client-side caching may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

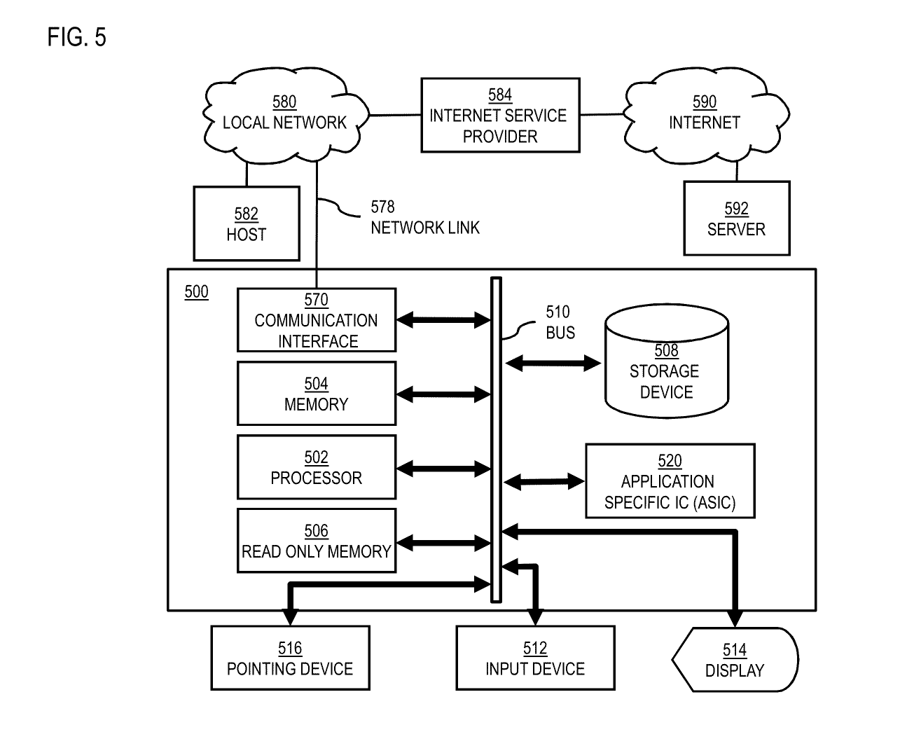

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide client-side caching of content as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of providing client-side caching of content.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to provide client-side caching of content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for providing client-side caching of content. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing client-side caching of content, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing client-side caching of content to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to provide client-side caching of content as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of providing client-side caching of content.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide client-side caching of content. The memory 605 also stores the data associated with or generated by the execution of the inventive steps.

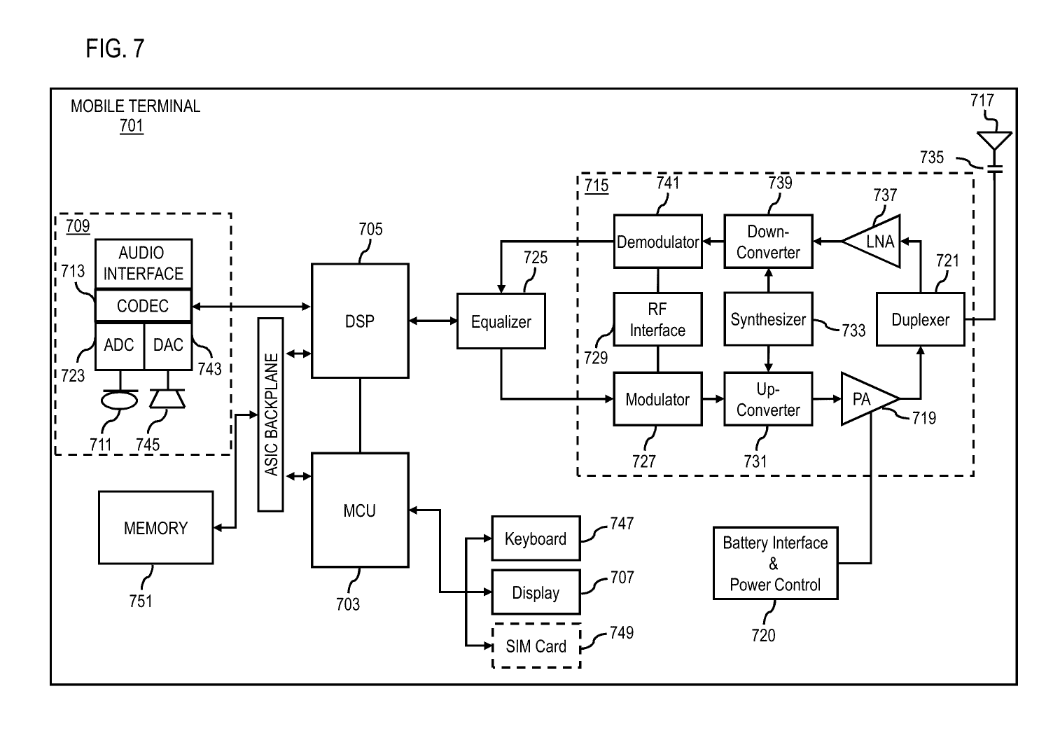

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of providing client-side caching of content. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of providing client-side caching of content. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide client-side caching of content. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request from a device, the request specifying content data directed to at least one web server, at least one storage destination, or a combination thereof;
a processing of the content data for storage in one or more web cookies; and
a transmission of the content data via the one or more web cookies to the at least one web server, the at least one storage destination, or a combination thereof based, at least in part, on the request.

2. A method of claim 1, wherein the (1) data and/or (2) information and/or (3) at least one signal are further based, at least in part, on the following:
at least one determination that the device has an offline status with respect to the at least one web server,
wherein the transmission of the content data via the one or more web cookies is based, at least in part, on a determination that the device has an online status with respect to the at least one web server.

3. A method of claim 1, wherein the (1) data and/or (2) information and/or (3) at least one signal are further based, at least in part, on the following:
a processing of a size of the content data to determine a number of the one or more web cookies for storing the content data; and
a creation of one or more store paths at the device based, at least in part, on the number,
wherein the one or more store paths are for storage of the one or more web cookies at the device.

4. A method of claim 3, wherein the (1) data and/or (2) information and/or (3) at least one signal are further based, at least in part, on the following:
a distribution of the content data for storage over the one or more web cookies; and
at least one determination to designate at least one of the one or more web cookies as a master record for the distribution,
wherein the master record indicates, at least in part, which of the one or more web cookies contain one or more portions of the distributed content data, the one or more store paths associated with the one or more web cookies, a sequence of accessing of the one or more web cookies, or a combination thereof.

5. A method of claim 3, wherein the (1) data and/or (2) information and/or (3) at least one signal are further based, at least in part, on the following:
a distribution of the content data for storage over the one or more web cookies based, at least in part, on the number.

6. A method of claim 3, wherein the (1) data and/or (2) information and/or (3) at least one signal are further based, at least in part, on the following:
a randomization, a lengthening, an obfuscation, a modification or a combination thereof of one or more path identifiers associated with the one or more store paths.

7. A method of claim 6, wherein the randomization, the lengthening, the obfuscation, the modification, or a combination thereof of the one or more path identifiers is via a rewrite engine associated with the at least one web server.

8. A method of claim 1, wherein the (1) data and/or (2) information and/or (3) at least one signal are further based, at least in part, on the following:
a concatenation of the content data stored in the one or more web cookies based, at least in part, on a status of a session between the device and the web server, a status of the transmission of the content data, or a combination thereof.

9. A method of claim 8, wherein the concatenation comprises, at least in part, appending an offline token corresponding to an offline session status, an online token corresponding to an online session status, or a combination thereof.

10. A method of claim 1, wherein the (1) data and/or (2) information and/or (3) at least one signal are further based, at least in part, on the following:
a processing of one or more scripts at the device to cause, at least in part, the storage of the content data in the one or more web cookies; and
at receipt of the one or more web cookies from the at least one web server.

11. An apparatus comprising:
at least one processor; and
at least one memory including computer program code for one or more programs,
the at least one memory and the computer program code configured to, with the at least one processor, cause the apparatus to perform at least the following,
determine a request from a device, the request specifying content data directed to at least one web server, at least one storage destination, or a combination thereof;
process and/or facilitate a processing of the content data for storage in one or more web cookies; and
cause, at least in part, a transmission of the content data via the one or more web cookies to the at least one web server, the at least one storage destination, or a combination thereof based, at least in part, on the request.

12. An apparatus of claim 11, wherein the apparatus is further caused to:
determine that the device has an offline status with respect to the at least one web server,
wherein the transmission of the content data via the one or more web cookies is based, at least in part, on a determination that the device has an online status with respect to the at least one web server.

13. An apparatus of claim 11, wherein the apparatus is further caused to:
process and/or facilitate a processing of a size of the content data to determine a number of the one or more web cookies for storing the content data; and
cause, at least in part, a creation of one or more store paths at the device based, at least in part, on the number,
wherein the one or more store paths are for storage of the one or more web cookies at the device.

14. An apparatus of claim 13, wherein the apparatus is further caused to:
cause, at least in part, a distribution of the content data for storage over the one or more web cookies; and
determine to designate at least one of the one or more web cookies as a master record for the distribution,
wherein the master record indicates, at least in part, which of the one or more web cookies contain one or more portions of the distributed content data, the one or more store paths associated with the one or more web cookies, a sequence of accessing of the one or more web cookies, or a combination thereof.

15. An apparatus of claim 13, wherein the apparatus is further caused to:
cause, at least in part, a distribution of the content data for storage over the one or more web cookies based, at least in part, on the number.

16. An apparatus of claim 13, wherein the apparatus is further caused to:
cause, at least in part, a randomization, a lengthening, an obfuscation, a modification or a combination thereof of one or more path identifiers associated with the one or more store paths.

17. An apparatus of claim 16, wherein the randomization, the lengthening, the obfuscation, the modification, or a combination thereof of the one or more path identifiers is via a rewrite engine associated with the at least one web server.

18. An apparatus of claim 11, wherein the apparatus is further caused to:
cause, at least in part, a concatenation of the content data stored in the one or more web cookies based, at least in part, on a status of a session between the device and the web server, a status of the transmission of the content data, or a combination thereof.

19. An apparatus of claim 18, wherein the concatenation comprises, at least in part, appending an offline token corresponding to an offline session status, an online token corresponding to an online session status, or a combination thereof.

20. An apparatus of claim 11, wherein the apparatus is further caused to:
process and/or facilitate a processing of one or more scripts at the device to cause, at least in part, the storage of the content data in the one or more web cookies; and
receiving the one or more web cookies from the at least one web server.

21-48. (canceled)
